(19) United States
(12) Patent Application Publication
(10) Pub. No.: US 2023/0382768 A1
(43) Pub. Date: Nov. 30, 2023

(54) PURIFICATION METHOD FOR LANDFILL LEACHATE

(71) Applicant: Cool Separations B.V., Poortugaal (NL)

(72) Inventors: Jaap VAN SPRONSEN, Noordwijk (NL); Mohammed ALJIRJAWI, Delft (NL); Jordy OTTEN, Poortugaal (NL)

(21) Appl. No.: 18/249,618

(22) PCT Filed: Oct. 25, 2021
(86) PCT No.: PCT/NL2021/050646

§ 371 Date: Apr. 19, 2023

(30) Foreign Application Priority Data
Oct. 23, 2020 (NL) 2026750

(51) Int. Cl. C02F 1/22; C01D 5/16; C01D 3/08; C01D 3/14; C01D 9/16; C02F 1/38; C02F 9/00

(52) U.S. Cl. CPC C02F 1/22; C01D 5/16; C01D 3/08; C01D 3/14; C01D 9/16; C02F 1/385; C02F 9/00; C02F 2001/5218

(57) ABSTRACT

The invention is in the field of landfill leachate, in particular the invention is directed to a method for purifying landfill leachate comprising water, dissociated ions and organic compounds, wherein the method comprises providing the leachate in a eutectic freeze crystallization (EFC) crystallizer and carrying out eutectic freeze crystallization by reducing the temperature of the leachate to a first eutectic point to obtain a first mixture comprising ice and a first crystalline salt. Further the ice and the first crystalline salt are separated into an ice stream and a crystalline salt stream.

The invention is in the field of landfill leachate, in particular the invention is directed to a method to purify the landfill leachate.

Due to the continuously increasing world population, industrialization and to the intensifying and expansion of the agricultural sector a significant increase in waste is realized. The waste is a large pollutant of the land, rivers, oceans and the atmosphere. It is therefore highly desired to convert to a more circular economy (i.e. a system of closed loops in which renewable sources are used and in which the used materials lose their value as little as possible) to minimize waste. For example, China has an urgent demand for a more circular economy as the rapid increase of their economic prosperity has a large impact on the environment. As a helping hand, an interest is taken to minimize pollution from landfill leachate.

Landfill leachate is a term that is used for water (e.g. precipitation) that has percolated through the waste, while gradually absorbing and/or dissolving contaminants such as salts, organic compounds and heavy metals. Dependent on the composition and the age of the landfill the leachate becomes more or less contaminated. As direct flow into the soil and/or groundwater is preferably prevented, many landfill sites have been engineered to have impermeable liners.

Instead of the direct flow into the soil and/or groundwater, the leachate may be collected and recirculated over the landfill. The recirculation typically enhances the (biological) breakdown and decomposition of the organic compounds to i.a. CO₂, water and natural gas. Additionally, recirculation may allow for the precipitation of at least a part of the heavy metal contaminants.

Further treatment of the leachate may comprise a variety of physical, chemical and/or biological processes such as pH modification and coagulation of solids. However, not all contaminants can be removed by recirculation and the further treatment as especially salts remain dissolved in the leachate. After the processing, the leachate is disposed of in the environment or alternatively, processed and diluted in a regular water treatment plant to comply with the national waste regulations before disposal.

However, the volume of the leachate may surpass the dilution capacity, or a country may not have the resources. Additionally, the disposal of the diluted leachate does not fit into a circular economy.

One method to further process the leachate is to concentrate the leachate by, for instance, reverse osmosis (herein also referred to as RO). RO uses a membrane that in principle only allows water molecules to pass. By applying pressure, the water is pushed through the membrane, thereby typically obtaining pure water on one side and a more concentrated leachate on the other side. The obtained concentration of the leachate is typically between 3-5 wt % TDS (total dissolved solids). Disposal of such a concentrated stream is not possible, and neither is further concentrating the stream by RO due to e.g. scaling. An alternative way to further increase the concentration is by recirculation over the landfill, and thereby letting the leachate absorb additional contaminants. However, this is now prohibited in several countries including China. Methods to dispose of the leachate include incineration, which is costly, and evaporation in evaporation ponds, which requires large surfaces of land. Therefore, an alternative and/or improved method to further purify the leachate is highly desired.

Several alternatives for treating landfill leachate have been proposed for example in CN103964609, where lime and sodium carbonate are added before filtrating and concentrating the leachate. Disadvantageously, a concentrated waste stream remains that needs to be disposed of. Another method is disclosed in CN102167452. However, the disclosed method requires several chemical processes (i.a. pH adjustment, wet catalytic oxidation).

Alternatively, an at least partially biological treatment for landfill leachate is disclosed in CN103319047. The biological treatment includes a multi-stage biological treatment unit which uses microorganisms. By using the disclosed method, the organic pollutants are degraded and heavy metals and phosphorus are removed. However, dependent on the concentration, up to 150 biochemical pools are required and care should be taken to provide a livable environment for the microorganisms.

Another alternative is solidification by evaporation in a continuous process. This process increases the temperature of the leachate to the boiling point resulting in evaporation of the water and solidification of the dissolved salts. The condensed water may be disposed of and the salts are subjected to centrifuging and are e.g. stored. However, this process is energy consuming, sensitive to corrosion and sensitive to scaling which typically requires the process to be placed on hold, consuming valuable time and energy. Additionally, due to the high temperature involved with the evaporation of water, an explosion risk is associated with this process as the salts may comprise ammonium and nitrates which could explosively react with each other.

Furthermore, the disclosed methods do not allow for individual isolation of the salts.

It is an object of the present inventors to provide an improved method for purifying landfill leachate that overcomes at least part of the above-mentioned drawbacks.

The present inventors found that a method comprising eutectic freeze crystallization enables purification of landfill leachate by the formation of ice and one or more pure crystalline salts. This is particularly surprising since landfill leachate comprises a complex mixture of dissolved salts and organic compounds.

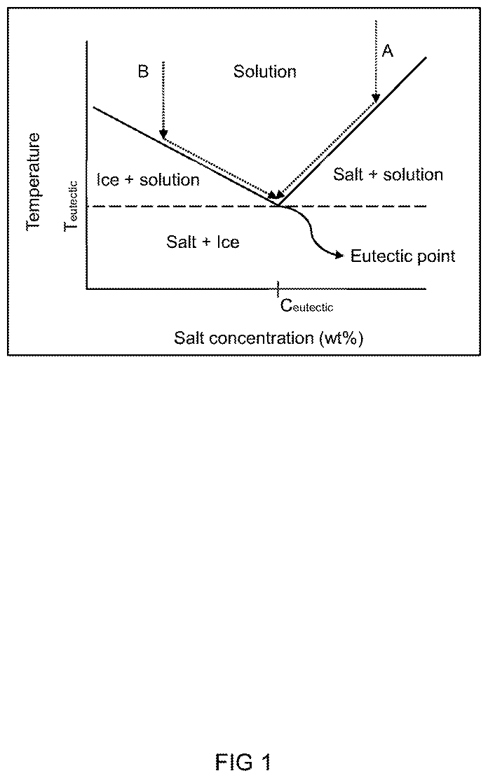

FIG. 1 illustrates a phase diagram for a binary aqueous salt solution.

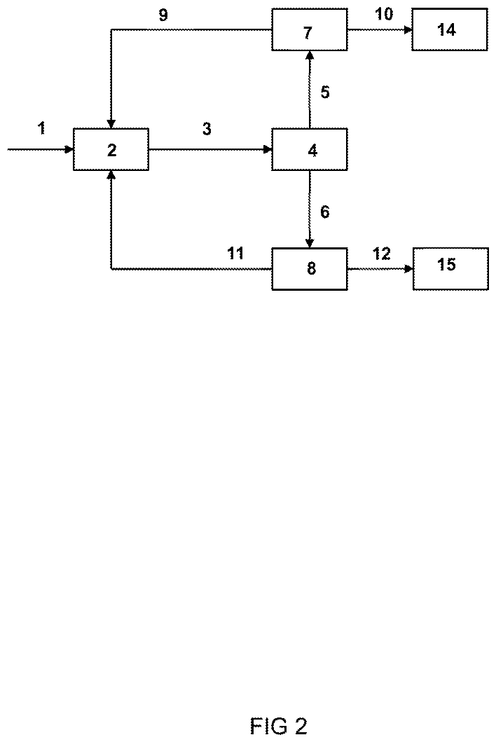

FIG. 2 illustrates a scheme of a preferred embodiment of the present invention comprising one EFC crystallizer.

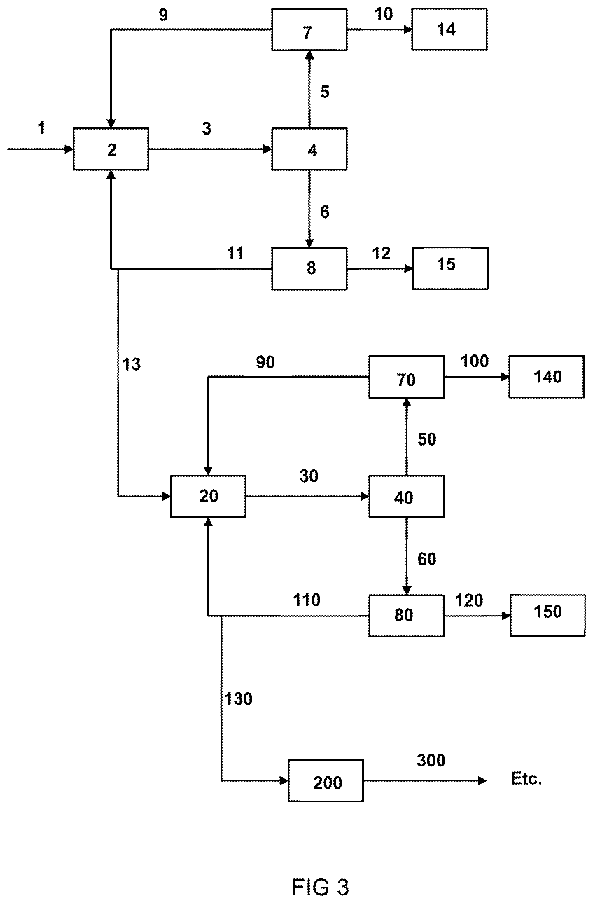

FIG. 3 illustrates a scheme of a yet another preferred embodiment of the present invention comprising more than one EFC crystallizer.

Accordingly, in a first aspect the invention is directed to a method for purifying landfill leachate (1) comprising water, dissociated ions and organic compounds, wherein the method comprises:
providing the leachate (1) in a eutectic freeze crystallization (EFC) crystallizer (2);
carrying out eutectic freeze crystallization by reducing the temperature of the leachate to a first eutectic point to obtain a first mixture (3) comprising ice and a first crystalline salt;
separating (4) the ice and said first crystalline salt into an ice stream (5) and a crystalline salt stream (6).

The leachate comprises water, dissociated ions and organic compounds. The dissociated ions typically originate from salts (e.g. CaSO₄, MgSO₄, Na₂SO₄, MgCl₂, Mg(NO₃)₂, Ca(NO₃)₂, CaCl₂, NaNO₃, NaCl, K₂SO₄, KNO₃, KCl) that have been dissolved in the water while percolating through the landfill. Accordingly, typical dissociated ions include, but are not limited to, magnesium (Mg²⁺), calcium (Ca²⁺), sodium (Na⁺), potassium (K⁺), sulfate (SO₄²⁻), nitrate (NO₃⁻), chloride (Cl⁻) and ammonium (NH₄⁺). Other ions may also be present at lower levels, dependent on the origin of the waste. The organic compounds that are often found in landfill leachate may comprise humic acids.

Typically, the leachate originates from the RO unit present on the landfill site (vide supra) or from one or more pretreatment steps (vide infra). Accordingly, the rate at which the leachate can be provided for the method according to the present invention may dependent on the capacity of the one or more previous steps. For instance, the leachate can be provided at a rate between 5-15 m³/hour, preferably between 8-12 m³/hour, such as 10 m³/hour. In order to fully utilize all the leachate that is provided, a number of parallel EFC crystallizers may be used over which the input of leachate is divided. For example, an EFC crystallizer with a volume of approximately 1.5 m³ can receive around 440 kg/hour of leachate. To treat all the leachate, it may be required to have several EFC crystallizers in parallel, such as 10 or 12. Alternatively, or additionally one or more larger EFC crystallizer may be used. This may be particularly beneficial when the leachate originates from the one or more previous steps at a rate between 15-120 m³/hour, preferably between 20-100 m³/hour.

After the provision of the leachate, a eutectic freeze crystallization (EFC) is carried out. EFC is a process that is known to recover ice and crystallizable compounds as disclosed in for instance EP2763769. The EFC process in general is described in e.g. Chapter 1 of Lu (2014), Novel Applications of Eutectic Freeze Crystallization, Delft University of Technology. The process can be seen as a combination of crystallization by concentration and crystallization by freezing and it is related to the thermodynamics of a system.

The method according to the present invention is carried out by lowering the temperature to a eutectic point. The eutectic point is a combination of a temperature and a concentration of the solution at which two components of the solution crystallize. The temperature and concentration at which the eutectic point can be found is dependent on the thermodynamic system of the leachate (i.a. the number of individual solutes) and may be determined from a phase diagram or may be experimentally found. A typical phase diagram (x-axis; concentration, y-axis: temperature at constant pressure) for binary aqueous solutions, such as an aqueous solution of a salt is illustrated in FIG. 1 and indicates the salt solubility line and the ice line. These lines divide the phase diagram into several regions. A region of one phase (i.e. solution), two phases (i.e. salt in equilibrium with the solution; ice in equilibrium with the solution; ice and salt) and three phases (ice, salt and solution in equilibrium). The point at which the three phases are in equilibrium reflects the eutectic point (i.e. the cross-section of the salt solubility line and the ice line), with a corresponding eutectic temperature and eutectic concentration. For a solution comprising several solutes, the phase diagram is more complex and several eutectic points can be determined.

In general, dependent on the concentration of the dissolved salt, either ice or the crystalline salt starts to form first. If the concentration of the dissolved salt is above the eutectic concentration and the temperature is lowered, the temperature will reach the salt solubility line at which point the salt begins to crystallize. The crystallization results in a lowering of the concentration of the dissolved salt in the leachate and thus by lowering the temperature the salt solubility line is followed up to the eutectic point. Here ice starts to form, and the ice and crystalline salt crystallize simultaneously, i.e. the eutectic point has been reached. This process is seen in FIG. 1 following path A.

Alternatively, path B of FIG. 1 may be followed if the concentration of the dissolved salt is below the eutectic concentration and the temperature is lowered, the temperature will reach the ice line at which ice starts to form. Due to the freezing out of the water, the concentration of the dissolved salt starts to increase and the ice line is followed to the eutectic point. At this point the salt starts to crystallize simultaneously with the ice, i.e. the eutectic point has been reached.

EFC is herein used for leachate, which is a more complex solution (e.g. with more solutes). The ice and a first salt crystallize at a first eutectic point, leaving the leachate with a higher concentration of the remaining solutes (i.e. dissociated ions and organic compounds). In subsequent steps the other solutes may crystallize one by one (vide infra). Which crystalline salt forms first is dependent on several factors, such as type and number of the dissociated ions and the concentration thereof. The organic compounds (e.g. type and concentration) may possibly also be of minor influence on the sequence of crystallization.

Accordingly, in the present invention, the ice forms simultaneously with the first crystalline salt in the eutectic freeze crystallization. As the provided leachate typically has a concentration of the dissociated ions corresponding to the first crystalline salt that is below the eutectic concentration, the ice typically forms before the formation of the first crystalline salt.

The method according to the present invention is associated with several benefits. A first benefit is that the crystallization of water of about ° C. into ice generally consumes 7 times less energy than evaporation of this water. Even if the evaporation process is fully optimized, a factor of at least 2 typically remains. Accordingly, the CO₂ emission from the EFC process may be significantly lower than from the evaporation process. Further, surprisingly, no scaling or at least substantially no scaling is observed when using EFC in accordance with the present invention for leachate. Moreover, the EFC allows collection of at least substantially pure crystalline salts. These salts have a positive commercial value, while a concentrate obtained by evaporation generally has a commercial negative value.

The temperature corresponding to the eutectic point is below 0° C., which concomitantly results in various advantages. At this low temperature little corrosion occurs, which may allow for cheaper materials to be used for i.a. the EFC crystallizer. Generally, the temperature limits the formation of gases, thereby preventing excessive foam formation. If some foam formation may occur in the process, an antifoam compound may be added to the leachate. The antifoam compound may for instance be added to the leachate before the leachate enters the EFC crystallizer and/or the antifoam compound may be added to the leachate in the EFC crystallizer. Suitable antifoam compounds may include silicon-based antifoams. Further, the low temperature may limit the formation of potentially explosive substances from nitrates and ammonium or organic compounds, which are typically present in the leachate. Moreover, even if these potentially explosive substances are formed, the low temperatures may limit the risk of explosion.

A particular embodiment of the invention is illustrated in FIG. 2. In this figure, the leachate (1) is provided in the eutectic freeze crystallization (EFC) crystallizer (2), wherein the eutectic freeze crystallization is carried out by reducing the temperature of the leachate to a first eutectic point to obtain a first mixture (3) comprising ice and a first crystalline salt. The first mixture (3) is thereby obtained comprising ice and a first crystalline salt, which can be separated in a separator (4), typically a static separator. As the density of ice is lower than the density of the leachate the ice tends to float. On the contrary, the density of the crystalline salt is typically higher than the solution, resulting in sinking of the salt. Due to the gravitational separation, separating the ice and said first crystalline salt into an ice stream and a crystalline salt stream is facilitated. In this preferred embodiment, the separation provides a first slurry stream (6) comprising the first crystalline salt and a second slurry stream (5) comprising the ice.

The first slurry stream may be subjected to recovery, for example in a first recovery device (8) such as a centrifuge, wherein the first crystalline salt (12) and a first mother liquor (11) are separated and individually recovered from the first slurry stream. Additionally, or alternatively, the ice (10) and a second mother liquor (9) are separated and individually recovered from the second slurry stream in a second recovery device (7), which can also comprise a centrifuge. Preferably the recovery comprises centrifuging the first and/or second slurry stream. In the recovery device, the salt and/or ice may also be subjected to washing. For instance, the ice in the second recovery device may be washed with molten ice. Mother liquor is herein used to describe the remaining fluid after recovery and separation of the crystalline salt and/or ice from the corresponding slurry stream (i.e. the first mother liquor is the fluid remaining after the removal of the first crystalline salt from the first slurry stream).

The first and/or second mother liquor that are separated and individually recovered typically comprise water, dissociated ions and organic compounds. However, a substantially large quantity of the dissociated ions corresponding to the first crystalline salt have been removed. As other dissociated ions as well as organic compounds remain in the mother liquor it may be subjected to eutectic freeze crystallization for further purification. Accordingly, it is preferred that the first and/or the second mother liquor is recycled back into the EFC crystallizer. The retentate liquid after washing may also be recycled back into the EFC crystallizer.

The ice and/or the first crystalline salt are preferably individually recovered. Surprisingly, the ice and/or the crystalline salt typically have a high purity. Not wishing to be bound by theory, the inventors believe that the high purities are achieved as impurities do not fit into the crystal lattices. The purity is preferably at least 80%, preferably at least 85%, more preferably at least 90%, even more preferably at least 95%, most preferably at least 99%. The purity is typically sufficient for the salts to have commercial value. Nonetheless, it may be advantageous to perform a work-up step, for example in a first washer (15) or a first RO unit (14), of the ice and/or the first crystalline salt to allow for any contaminations that e.g. surround the crystal lattices to be removed. Preferably, the ice is worked-up in an RO-unit (14). The work-up step accordingly preferably comprises purification such as washing, recrystallization and/or reverse osmosis, preferably reverse osmosis and recrystallization, most preferably reverse osmosis.

Furthermore, as indicated in FIG. 3, a first bleed stream (13) may be subtracted from the first mother liquor. This first bleed stream is thus at least part of the first mother liquor and therefore comprises water, dissociated ions and organic compounds. This first bleed stream may be provided in a second EFC crystallizer (20) to carry out a second EFC by reducing the temperature of the first bleed stream to a second eutectic point to obtain a second mixture (30) comprising ice and a second crystalline salt. After which the ice and said second crystalline salt may be separated in a second separator (40), also typically a static separator, into a second ice stream (50) and a second crystalline salt stream (60). Typically, the second eutectic point is below the first eutectic point.

Similarly, separation, optional recovery and the optional work-up step as described above may be performed to obtain ice and the second crystalline salt. FIG. 3 illustrates that the second ice stream (50) may be subjected to recovery in a third recovery device (70), for example a third centrifuge, to separate and individually recover a third mother liquor (90) and ice (100), which ice may be further subjected to a work-up step, for example in a second RO unit (140) or in the first RO unit (14) (not illustrated). Additionally, FIG. 3 illustrates that the second crystalline salt stream (60) may be subjected to recovery in a fourth recovery device (80), for example a fourth centrifuge, to separate and individually recover a fourth mother liquor (110) and the second crystalline salt (120) that may be subjected to a work-up step, for example in a second washer (150) or in the first washer (15) (not illustrated).

The method may be continued similarly by providing a further bleed stream (130) to be provided in a further EFC crystallizer (200) to carry out a further EFC by reducing the temperature of the further bleed stream to a further eutectic point to obtain a further mixture (300) comprising ice and a further crystalline salt. This further bleed stream, further EFC crystallizer, further mixture, further crystalline salt and further eutectic point may for instance be a second bleed stream, a third EFC crystallizer, a third mixture, a third crystalline salt and a third eutectic point. The third bleed stream may comprise at least part of the fourth mother liquor. Each further eutectic point is preferably lower than the previous eutectic points, i.e. the third eutectic point is preferably lower than the second eutectic point and the second eutectic point is preferably lower than the first eutectic point. By the sequential EFC processes, crystalline salts form one by one simultaneously with ice. The method thus preferably provides a method to sequentially separate, optionally recover crystalline salts and optionally to work-up the crystalline salts. For instance, the first crystalline salt may comprise Na₂SO₄ (such as sodium sulfate decahydrate), the second crystalline salt may comprise KNO₃ and a third crystalline salt may comprise NaCl.

In a typical embodiment, the removal of the first three salts (e.g. KNO₃, NaCl, Na₂SO₄) leads to a volume reduction of more than 98%, based on the volume of the leachate. The volume reduction may be achieved by solely the removal of the salts using the EFC crystallizer or may be achieved by the removal in combination with a pre-treatment. The remaining salts and organics (approximately 0.6% based on the original amount in the leachate) are dissolved in a remaining bleed stream at an estimated concentration of over 35%. The bleed stream may accordingly be about 2% of the initial leachate volume.

In another embodiment, only KNO₃ and Na₂SO₄ may be removed from the leachate and accordingly a volume reduction of 90%, based on the volume of the leachate, may be achieved. Again, the volume reduction may be achieved by solely the removal of the salts using the EFC crystallizer or may be achieved by the removal in combination with a pre-treatment

As a last stage of the process, a final solidification may be carried out on a last bleed stream to obtain essentially zero liquid discharge by reducing the temperature below the eutectic points to obtain a final mixture comprising ice and a final solid. Liquid discharge refers to the remaining contaminated liquid. Thus, the ice that is collected and may be melted to water is not considered liquid discharge. With essentially zero liquid discharge is meant that the leachate is converted into ice, the crystalline salts, solid organics and a minimal contaminated waste stream. The method preferably removes all contaminants from the leachate in its solid form, thereby rendering zero liquid discharge. This final EFC is performed by lowering the temperature below all eutectic points (i.e. the eutectic points corresponding to all dissolved solids). Generally, this allows for the formation of ice and the precipitation of all dissolved solids to the final solid, after which the ice and the final solid may be separated, individually recovered and may be subjected to work-up step. It is particularly beneficial if the final solidification is carried out to remove the last contaminants (i.a. organic compounds) after one or more EFCs to obtain crystalline salts. The quantity of the final solid is then typically small.

Depending on the concentration of the leachate, it may be preferred to subject the leachate to a pretreating step before it is provided in the EFC crystallizer. The pretreatment step may comprise a lime softening step, a coagulation step or for instance a flocculation step which typically allows for scaling components to be removed. Scaling is mainly due to the formation of for instance CaSO₄, CaCO₃, BaSO₄, CaF₂. Due to limited scaling, the leachate may be further concentrated. Accordingly, the pretreatment step may further comprise a concentration step, preferably by RO, to increase the TDS concentration, preferably to a concentration of at least 4 wt %, more preferably up to at least 5 wt %, most preferably to a concentration of at least 6 wt %. The increased concentration is particularly preferred for economic reasons.

Furthermore, the method may be a batch or a continuous method. Preferably a continuous method to provide continuous purification of the landfill leachate.

For the purpose of clarity and a concise description, features are described herein as part of the same or separate embodiments. However, it will be appreciated that the scope of the invention may include embodiments having combinations of all or some of the features described.

The invention is further illustrated by the following example.

### EXAMPLE 1

A raw landfill leachate was pretreated in a lime softening and coagulation step followed by reverse osmosis (RO) to provide a leachate. The leachate contained 0.7% sodium sulfate, 3.4% sodium chloride, 1.2% potassium nitrate, 0.5% other ions and a total organic carbon (TOC) of 0.1%. The leachate was fed into an EFC crystallizer, with a volume of 1.5 m³, equipped with scraped surface heat exchangers at a flow rate of 440 kg/hour. The temperature inside the EFC crystallizer was maintained at −14° C. by cooling over the heat exchangers. At this temperature ice and sodium sulfate decahydrate crystallized from solution. The first mixture from the EFC crystallizer (i.e. a crystal slurry mixture) was pumped into a static separator at a flowrate of 1600 l/hour. From the bottom of the static separator the first slurry stream (a sodium sulfate decahydrate slurry) was fed into a centrifuge at a flowrate of 200 l/h. The first mother liquor from the centrifuge was fed back into the EFC crystallizer. The sodium sulfate decahydrate crystals from the centrifuge were produced at a production rate of 6 kg/h and were substantially pure. From the top of the static separator the second slurry stream (ice slurry) was fed into a centrifuge at a flow rate of 1400 l/h. The ice crystals were washed in the centrifuge with molten ice. After discharge from the centrifuge the ice crystals were molten by heating. The TDS of the molten ice was 0.5% and the molten ice was further subjected to a work-up step by purification in a RO polishing step. The retentate of the RO was fed back into the EFC crystallizer. From the first mother liquor recycle a continuous first bleed stream was collected at 90 kg/hour. The first bleed stream contained 0.6% sodium sulfate, 14% sodium chloride, 5% potassium nitrate, 2% other ions and a TOC of 0.3%. 16 m³ of the first bleed stream was collected and used for the next EFC step.

The first bleed stream was fed into a second EFC crystallizer equipped with scraped surface heat exchangers at a flow rate of 440 kg/hour. The temperature inside the EFC crystallizer was maintained at −25° C. by cooling over the heat exchangers. At this temperature ice, potassium nitrate and a small amount of sodium sulfate decahydrate crystallized from solution. The second mixture from the second EFC crystallizer was pumped into a second static separator at a flowrate of 1600 l/hour. From the bottom of the second static separator the fourth slurry stream (potassium nitrate slurry) was fed into a centrifuge at a flowrate of 200 l/h. The fourth mother liquor from the centrifuge was fed back into the EFC crystallizer. The potassium nitrate crystals from the centrifuge were produced at a production rate of 17 kg/h. From the top of the static separator the third slurry stream (ice slurry) was fed into a centrifuge at a flow rate of 1400 l/h. The ice crystals were washed in the centrifuge with molten ice. After discharge from the centrifuge the ice crystals were molten by heating. The TDS of the molten ice was 1% and the molten ice was further subjected to a work-up step by purification in a RO polishing step. The retentate of the RO was fed back into the EFC crystallizer. From the fourth mother liquor recycle a continuous further bleed stream was collected at 235 kg/hour. This further bleed stream contained 0.6% sodium sulfate, 24% sodium chloride, 3% potassium nitrate, 4% other ions and a TOC of 0.5%.

1. A method for purifying landfill leachate comprising water, dissociated ions and organic compounds, wherein the method comprises:
(a) providing the leachate in a eutectic freeze crystallization (EFC) crystallizer;
(b) carrying out eutectic freeze crystallization by reducing the temperature of the leachate to a first eutectic point to obtain a first mixture comprising ice and a first crystalline salt;
(c) separating the ice and said first crystalline salt into an ice stream and a crystalline salt stream to provide a first slurry stream comprising the first crystalline salt and a second slurry stream comprising the ice;
(d) separating and individually recovering the first crystalline salt and a first mother liquor from the first slurry stream;
(e) providing a first bleed stream which is at least part of the first mother liquor in a second eutectic freeze crystallization (EFC) crystallizer;
(f) carrying out eutectic freeze crystallization by reducing the temperature of the first bleed stream to a second eutectic point to obtain a second mixture comprising ice and a second crystalline salt; and
(g) separating the ice and said second crystalline salt into a second ice stream and a second crystalline salt stream.

2. The method of claim 1, wherein in step (b), the ice forms simultaneously with the formation of the first crystalline salt.

3. The method of claim 1, further comprising separating and individually recovering the ice and a second mother liquor from the second slurry stream, wherein the recovering comprises centrifuging the first slurry stream, the second slurry stream, or both the first slurry stream and the second slurry stream.

4. The method of claim 1, wherein a part of the first mother liquor, the second mother liquor, or both the first mother liquor and the second mother liquor is recycled back into the EFC crystallizer.

5. The method of claim 1, further comprising a work-up step comprising purifying the ice, the first crystalline salt, or both the ice and the first crystalline salt.

6. The method of claim 1, wherein the temperature of the second eutectic point is below that of the first eutectic point.

7. The method of claim 1, further comprising separating and individually recovering a fourth mother liquor and the second crystalline salt from the second crystalline salt stream in a fourth recovery device.

8. The method of claim 7, further comprising:
providing a second bleed stream which is at least part of the fourth mother liquor in a third eutectic freeze crystallization (EFC) crystallizer;
carrying out eutectic freeze crystallization by reducing the temperature of the second bleed stream to a third eutectic point to obtain a third mixture comprising ice and a third crystalline salt; and
separating the ice and said third crystalline salt into an ice stream and a third crystalline salt stream.

9. The method of claim 8, wherein the first crystalline salt comprises Na₂SO₄, the second crystalline salt comprises KNO₃, and the third crystalline salt comprises NaCl.

10. The method of claim 1, further comprising:
carrying out a final solidification by reducing the temperature below the eutectic points corresponding to the dissociated ions and organic compounds to obtain a final mixture comprising ice and a final solid; and
separating the ice and said final solid into an ice stream and a final solid stream,
thereby obtaining essentially zero liquid discharge.

11. The method of claim 1, wherein the leachate is subjected to a pretreating before it is provided in the EFC crystallizer, said pretreating comprising:
(a) a flocculation step, a coagulation step, and a lime softening step;
(b) a concentrating step; or
(c) both (a) and (b),
wherein the pretreating increases the concentration of total dissolved solids (TDS), to a concentration of at least 4 wt %.

12. The method of claim 1, wherein the dissociated ions are selected from: magnesium (Mg²⁺), calcium (Ca²⁺), sodium (Na⁺), potassium (K⁺), sulfate (SO₄²⁻), nitrate (NO₃⁻), chloride (Cl⁻) and ammonium (NH₄⁺).

13. The method of claim 1, further comprising adding an antifoam compound (a) to the leachate in the EFC crystallizer, (b) to the leachate before providing the leachate in the EFC crystallizer, or (c) to the leachate both in the EFC crystallizer and before providing the leachate in the EFC crystallizer.

14. The method of claim 1, wherein the method is a continuous method.

15. The method of claim 1, wherein in step (b), the ice forms before and with the formation of the first crystalline salt.

16. The method of claim 5, wherein the purifying comprises washing, recrystallization, reverse osmosis, or a combination thereof.

17. The method of claim 8, wherein the temperature of the third eutectic point is below that of the second eutectic point.

18. The method of claim 11, wherein the concentrating step (step (b)), comprises reverse osmosis.

19. The method of claim 11, wherein the pretreating increases the concentration of TDS to a concentration of up to at least 5 wt %.

20. The method of claim 11, wherein the pretreating increases the concentration of TDS to a concentration of up to at least 6 wt %.
